(19) United States
(12) Patent Application Publication
(10) Pub. No.: US 2022/0406132 A1
(43) Pub. Date: Dec. 22, 2022

(54) ALERTING METHOD AND DEVICE, APPARATUS AND COMPUTER STORAGE MEDIUM

(71) Applicant: SENSETIME INTERNATIONAL PTE. LTD., Singapore (SG)

(72) Inventors: Miao OUYANG, Singapore (SG); Xinxin Wang, Singapore (SG)

(21) Appl. No.: 17/364,337

(22) Filed: Jun. 30, 2021

Related U.S. Application Data
(63) Continuation of application No. PCT/IB2021/055733, filed on Jun. 28, 2021.

(30) Foreign Application Priority Data
Jun. 16, 2021 (SG) 10202106454Q

(51) Int. Cl. G07F 17/32; G06K 9/00

(52) U.S. Cl. CPC G07F 17/3241; G07F 17/322; G07F 17/3232; G06K 9/00744

(57) ABSTRACT

An alerting method includes: acquiring a result of a game played at a game table and multiple frames of first images obtained by shooting the game table at a settlement stage of the game; the game table including at least one placement area for placing game currencies; determining, based on the multiple frames of the first images, an actual settlement action of a game controller for each placement area, wherein the actual settlement action comprises at least one of an action of collecting the game currencies or an action of delivering the game currencies; determining, based on the result of the game, a settlement action required to be performed by the game controller; and outputting alert information in a case that the actual settlement action does not match the settlement action required to be performed.

### CROSS-REFERENCE TO RELATED APPLICATIONS

This application is a continuation of International Application No. PCT/IB2021/055733, filed on 28 Jun. 2021, which claims priority to Singaporean Patent Application No. 10202106454Q, filed with IPOS on 16 Jun. 2021. The disclosures of International Application No. PCT/IB2021/055733 and Singaporean Patent Application No. 10202106454Q are hereby incorporated by reference in their entireties.

### BACKGROUND

After the outcome of a round of game, a game controller typically collects game currencies from a placement area of a game table of which the corresponding player is a loser, and delivers the game currencies to a placement area of the game table of which the corresponding player is a winner. However, it is common for the game controller to fail to collect or deliver the game currencies on the game table according to a prescribed settlement action, which likely causes loss to a game venue or a player.

However, there is no technique in the related art for detecting the action of the game controller to collect or deliver the game currencies on the game table.

### SUMMARY

Embodiments of the present disclosure relate to, but are not limited to, games, and more particularly, to an alerting method and device, an apparatus and a computer storage medium.

Embodiments of the present disclosure provide an alerting method and device, an apparatus, and a storage medium.

According to a first aspect, an alerting method is provided. The method includes acquiring a result of a game played at a game table and multiple frames of first images obtained by shooting the game table at a settlement stage of the game; the game table including at least one placement area for placing game currencies; determining, based on the multiple frames of the first images, an actual settlement action of a game controller for each placement area, wherein the actual settlement action includes at least one of an action of collecting the game currencies or an action of delivering the game currencies; determining, based on the result of the game, a settlement action required to be performed by the game controller; outputting alert information in a case that the actual settlement action does not match the settlement action required to be performed.

According to a second aspect, an alerting device is provided. The device includes: a memory storing processor-executable instructions; and a processor configured to execute the stored processor-executable instructions to perform operations of: acquiring a result of a game played at a game table and a plurality of frames of first images obtained by shooting the game table at a settlement stage of the game, the game table comprising at least one placement area for placing game currencies; determining, based on the plurality of frames of the first images, an actual settlement action of a game controller for each placement area, wherein the actual settlement action comprises at least one of an action of collecting the game currencies or an action of delivering the game currencies; determining, based on the result of the game, a settlement action required to be performed by the game controller; and outputting alert information in a case that the actual settlement action does not match the settlement action required to be performed.

According to a third aspect, a non-transitory computer storage medium is provided. The non-transitory computer storage medium has stored thereon computer-executable instructions that, when executed by a processor, cause the processor to perform operations of: acquiring a result of a game played at a game table and a plurality of frames of first images obtained by shooting the game table at a settlement stage of the game, the game table comprising at least one placement area for placing game currencies; determining, based on the plurality of frames of the first images, an actual settlement action of a game controller for each placement area, wherein the actual settlement action comprises at least one of an action of collecting the game currencies or an action of delivering the game currencies; determining, based on the result of the game, a settlement action required to be performed by the game controller; and outputting alert information in a case that the actual settlement action does not match the settlement action required to be performed.

### BRIEF DESCRIPTION OF THE DRAWINGS

FIG. 1 is a structural diagram of an alert system according to an embodiment of the present disclosure;

FIG. 2 is a flowchart of an alerting method according to an embodiment of the present disclosure;

FIG. 3 is a flowchart of another alerting method according to an embodiment of the present disclosure;

FIG. 4 is a flowchart of still another alerting method according to an embodiment of the present disclosure;

FIG. 5 is a flowchart of yet another alerting method according to an embodiment of the present disclosure;

FIG. 6 is a flowchart of an alerting method according to another embodiment of the present disclosure;

FIG. 7 is a flowchart of an alerting method according to still another embodiment of the present disclosure;

FIG. 8 is a flowchart of an alerting method according to still another embodiment of the present disclosure;

FIG. 9 is a flowchart of another alerting method according to still another embodiment of the present disclosure;

FIG. 10 is a structural diagram of an alerting device according to an embodiment of the present disclosure;

FIG. 11 is a schematic diagram of a hardware entity of an alerting apparatus according to an embodiment of the present disclosure.

### DETAILED DESCRIPTION

The technical solution of the present disclosure is described in detail by way of example and in conjunction with the accompanying drawings. The following specific embodiments may be combined with each other, and details may not be repeated for the same or similar concepts or processes in certain embodiments.

It should be noted that in the present disclosure examples, “first”, “second”, and the like are used to distinguish between similar objects and not necessarily to describe a particular order or precedence order. In addition, any combination of the technical solutions described in the embodiments of the present disclosure may be used without conflict.

Expression such as at least one and at least one frame in the embodiments of the present disclosure may refer to one or at least two, and one frame or at least two frames, respectively. Expressions such as multiple and multiple frames in the embodiments of the present disclosure may refer to at least two, and at least two frames, respectively. In the embodiments of the present disclosure, at least one frame of image B taken after at least one frame of image A may mean that at least one frame of image B is adjacent to at least one frame of image A, or may mean that at least one frame of image B is spaced apart from at least one frame of image A by one or more frames of image(s). Here, image A or image B may mean any image occurring in the embodiments of the present disclosure, which are not enumerated in the embodiments of the present disclosure.

In embodiments of the present disclosure, at least one frame of image C may be a continuously shot image C, or may be a discontinuously shot image C. The number of images C may be determined based on actual circumstances, and is not limited in the embodiments of the present disclosure. Image C may refer to any image that occurs in the embodiments of the present disclosure.

The alerting method provided by the embodiment of the disclosure may be applied to casino scenarios. In casino scenarios, a player referred to in any one of the embodiments of the present disclosure may include a player or a banker, a game controller referred to in any one of the embodiments of the present disclosure may refer to a dealer, a game table referred to in any one of the embodiments of the present disclosure may refer to a gambling table, a game currency referred to in any one of the embodiments of the present disclosure may include a chip, and a placement area referred to in any one of the embodiments of the present disclosure may refer to a wager area or a betting area on a game table. A management system referred to in any one of the embodiments of the present disclosure may refer to a Casino Management System (CMS).

In some embodiments, the game on the game table may be the baccarat. In other embodiments, the games on the game table may be other games, e.g., Three card brag, Cattle, Fishing, Texas Poker, Slot machine, or Five card stud, Pai Gow or Fighting Against Landlords or the like. The types of games are not limited in the embodiments of the present disclosure. The game on the game table may be a card game or a non-card game.

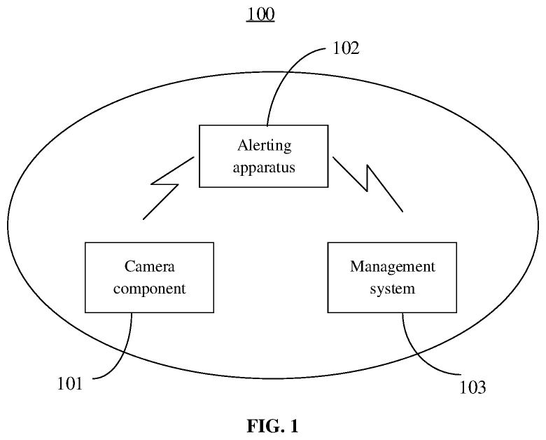

FIG. 1 is a structural diagram of an alert system according to an embodiment of the present disclosure. As shown in FIG. 1, an alert system 100 may include a camera component 101, an alerting apparatus 102, and a management system 103.

In some embodiments, the camera component 101 may include multiple cameras that may shoot the game table from different angles. For example, the camera component 101 may include three cameras, among which the first camera may be an aerial camera and may be mounted on the top of the game table. The second camera and the third camera are mounted on the sides of the game table, respectively, and the included angle between the second camera and the third camera is a set included angle. For example, the set included angle may be between 30 degrees and 120 degrees, and the set included angle may be 30 degrees, 60 degrees, 90 degrees, or 120 degrees. The second camera and the third camera may be provided on the game table to capture images of the game currencies and players on the game table from a side view.

In some embodiments, the alerting apparatus 102 may correspond to only one camera component 101. In other embodiments, the alerting apparatus 102 may correspond to multiple camera components 101. For example, the multiple camera components 101 corresponding to the alerting apparatus 102 may be camera components 101 used for shooting a game table in one or more game venues, or the multiple camera components 101 corresponding to the alerting apparatus 102 may be camera components 101 used for shooting a game table in a partial area of a game venue. The partial area may be an ordinary area or a Very Important Person (VIP) area or the like.

In some embodiments, the alerting apparatus 102 may be disposed in a gaming venue. For example, the alerting apparatus 102 may be connected to a server in a gaming venue. In other embodiments, the alerting apparatus 102 may be disposed on the cloud.

The camera component 101 may be in communication with the alerting apparatus 102. In some embodiments, the camera component 101 may periodically or aperiodically capture a real-time image and send the captured real-time image to the alerting apparatus 102. For example, in a case that the camera component 101 includes multiple cameras, the multiple cameras may shoot the real-time image at target time intervals, and send the shot real-time image to the alerting apparatus 102. Herein, the multiple cameras may shoot the real-time image simultaneously or not simultaneously. In other embodiments, the camera component 101 may take a real-time video shot and send the real-time video shot to the alerting apparatus 102. For example, in a case that the camera component 101 includes multiple cameras, the multiple cameras may respectively send the captured real-time video shot to the alerting apparatus 102 such that the alerting apparatus 102 intercepts the real-time image from the real-time video shot. The real-time image in the embodiment of the present disclosure may be any one or more of the following.

In some embodiments, the camera component may continuously shoot the image, and continuously send the shot image to the alerting apparatus 102. In other embodiments, the camera component may start shooting the image in response to a target trigger. For example, the camera component may start shooting the image in response to a result of the game or an instruction indicating that the placing of the game currencies is completed.

The alerting apparatus 102 may analyze the game currencies on the game table in the game venue and the game controller and player next to the game table based on the real-time image, so as to determine whether the action of at least one of the game controller or player conforms to regulations or are justified.

The alerting apparatus 102 may be in communication with the management system 103. In a case that the alerting apparatus 102 determines that the action of the game controller or the player is improper, in order to reduce the loss to the game venue or the player, the alerting apparatus 102 may send an alert message to the management system 103 on the game table corresponding to the game controller or the player of which the action is improper, such that the management system 103 may give an alert corresponding to the alert message, thereby giving an alert to the game controller or the player through the game table, and giving an early warning on the loss caused to the game venue or the player due to the improper action of the game controller or the player, so as to correct the action or take other measures in time.

The embodiments of the disclosure are not limited thereto. In the embodiment corresponding to FIG. 1, the illustrated camera component 101, alerting apparatus 102, and management system 103 are separate, respectively, but in other embodiments, the camera component 101 and the alerting apparatus 102 may be integrated together, or the alerting apparatus 102 and the management system 103 may be integrated together.

An alerting method according to an embodiment of the present disclosure is described below. in the method, an actual settlement action of a game controller at a settlement stage of a game may be detected, and in a case that the actual settlement action of the game controller matches a settlement action required to be performed by the game controller, an alerting device is used to alert the game controller, such that an early warning on a loss in the game venue due to an improper actual settlement action of the game controller may be given in time.

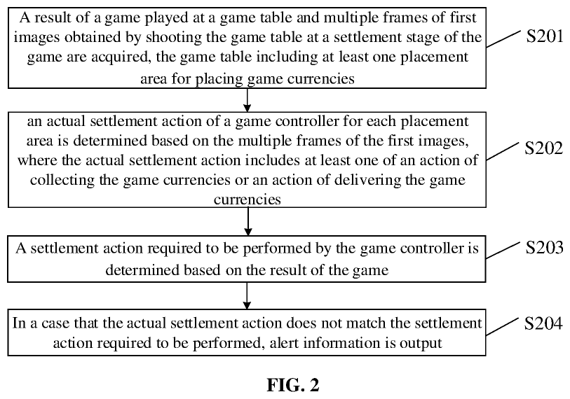

FIG. 2 is a flowchart of an alerting method according to an embodiment of the present disclosure. As shown in FIG. 2, the method is applied to an alerting apparatus. The method includes operations S201 to S204.

In S201, a result of a game played at a game table and multiple frames of first images obtained by shooting the game table at a settlement stage of the game are acquired. The game table includes at least one placement area for placing game currencies.

In some embodiments, the alerting apparatus may include an edge device, an edge apparatus or an edge node. The alerting apparatus may be communicatively connected to a server in the game venue, such that the server may control the alerting apparatus accordingly, and the alerting apparatus may further use a service provided by the server. In some embodiments, there is a one-to-one correlation between the alerting apparatus and the game table. In other embodiments, one alerting apparatus may correspond to multiple game tables.

In some embodiments, the camera component may be provided on the alerting apparatus to shoot the game table using the camera component, so as to obtain multiple frames of the first images and multiple frames of second images described below. In other embodiments, the camera component and the alerting apparatus are arranged separately, and the camera component may shoot the game table and send the shot real-time image to the alerting apparatus such that the alerting apparatus determines multiple frames of the first images and multiple frames of second images based on the real-time image. In still other embodiments, the camera component on the alerting apparatus may take a video shot at the game table and intercept the video shot, so as to obtain multiple frames of the first images and multiple frames of second images described below. In still other embodiments, the camera component may take a video shot at the game table and send the video shot to the alerting apparatus such that the alerting apparatus may intercept the received video, so as to obtain multiple frames of the first images and multiple frames of second images based on the intercepted image.

A round of game may include a game prop operation stage and a settlement stage, and further include a game currency placement stage. At the game currency placement stage, the game player may select a placement area representing a party, and place the game currencies therein. In the game prop operation stage, the game controller may operate the game prop on the game table to obtain the result of the game. After the result of the game occurs, the alerting apparatus may determine, based on the result of the game, that each placement area is a placement area of which the corresponding player is a winner, or a placement area of which the corresponding player is a loser. The game proceeds to the settlement stage of the game after the result of the game comes out. In the settlement stage, the player are not allowed to change the game currencies in any of the placement areas on the game table, and the game controller may collect the game currencies in the placement area of the loser and deliver the game currencies in the placement area of the winner. Herein, the placement area of the winner may represent that the player owning the game currencies placed in the placement area is the winner, and the placement area of the loser may represent that the player owning the game currencies placed in the placement area is the loser.

By way of example of a card game, after the game is started, a player may place game currencies in one or more of the at least one placement areas, the game controller may deal cards to each player on the game table. After the deal is over, the player may show their card face, and the alerting apparatus may determine the result of the game based on the shot card face, thereby determining, based on the result of the game, a settlement action required to be performed by the game controller. The game controller may further determine which player is the winner and which player is the loser based on the card face of the player. After the result of the game comes out, the game controller may collect the game currencies placed by the loser and deliver the game currencies placed by the winner. The delivery of the game currencies placed by the winner may be a delivery of the game currencies placed by the winner at a predetermined odds.

The multiple frames of the first images and the multiple frames of second images in the embodiments of the present disclosure may refer to images obtained by shooting a game table in a round of game or a game.

In S202, an actual settlement action of a game controller for each placement area is determined based on the multiple frames of the first images Herein, the actual settlement action includes at least one of an action of collecting the game currencies or an action of delivering the game currencies.

In some embodiments, the game controller may hold a game currency collection device, which may be a game chip collection device for collecting chips placed by the player. The game controller may perform settlement on the game currencies on the game table through the game currency collection device. The alerting apparatus may determine whether the action of collecting the game currencies or the action of delivering the game currencies is preformed through the collection device for each placement area based on the multiple frames of first images, and further determine whether the actual settlement action of the game controller for each placement area matches the settlement action required to be performed. In other embodiments, the game controller may collect or deliver the game currencies in each placement area by hand. Since the position of the game controller on the game table is different from the position of the player (for example, the positions on the opposite sides of the game currency placement area, respectively), the alerting device may determine the action of collecting the game currencies or the action of delivering the game currencies of the game controller in each placement area based on the hand action in the preset direction on the game table and the change of the game currencies in each placement area, and further determine whether the actual settlement action of the game controller for each placement area matches to the settlement action required to be performed. Or, by identifying the identity of the person associated with the hand appearing in each placement area, it is possible to determine whether the person operating the game currencies in the placement area is the game controller, and further to determine the operation performed by the game controller on the game currencies in each placement area.

The actual settlement action of the game controller may be a settlement action currently performed by the game controller, and the actual settlement action of the game controller may be a collection action or a delivery action of the game controller. The collection action is an action of collecting the game currencies, and the delivery action is an action of delivering the game currencies. A delivery action may be understood as a payout action. In practice, a game controller may be considered to perform an action of delivering the game currencies to a player when the game controller adds one or more chips in the game currency placement area, or pushes the chip(s) in the game currency placement area towards the player.

In S203, a settlement action required to be performed by the game controller is determined based on the result of the game.

The settlement action required to be performed by the game controller may be a take pay action to be followed by the game controller. For example, the take pay action to be followed may include at least one of the following: game currencies in the placement area of the loser are collected; the game currencies in the placement area of the winner are delivered; or the game currencies are not delivered in the placement area of the winner until all the game currencies in the placement area of the loser have been collected.

For example, in a case that the game is a card game, the result of the game may be the card rank of the card(s) held by each player. In a case that the game is a dice game, the result of the game may be the point value of the dice. The alerting apparatus may determine, based on the result of the game, that each placement area where the game currencies are placed is the placement area of the winner or the placement area of the loser.

In some embodiments, when it is determined, based on the result of the game, that the game currencies in the first and second placement areas on the game table are game currencies in the placement area of the loser and that the game currencies in the third placement area are game currencies in the placement area of the winner, the settlement action required to be performed by the game controller may include delivering the game currencies in the third placement area after the game currencies in the first and second placement areas are collected.

In S204, in a case that the actual settlement action does not match the settlement action required to be performed, alert information is output.

In some embodiments, determining that the actual settlement action of the game controller does not match the settlement action required to be performed may include that the actual settlement action of the game controller is different from the settlement action required to be performed by the game controller. In the implementation, the actual settlement action of the game controller may refer to the actual settlement action of the game controller for each placement area where the game currencies are placed.

In the embodiment of the disclosure, the actual settlement action of the game controller may be detected, and in a case that the actual settlement action of the game controller does not match the settlement action required to be performed by the game controller, the alert information is output, such that the detection of the actual settlement action of the game controller is achieved, and the alert information prompts the game controller to withdraw the actual settlement action not matching the settlement action required to be performed, thereby reducing the loss to a game venue or a player due to an erroneous action of the game controller.

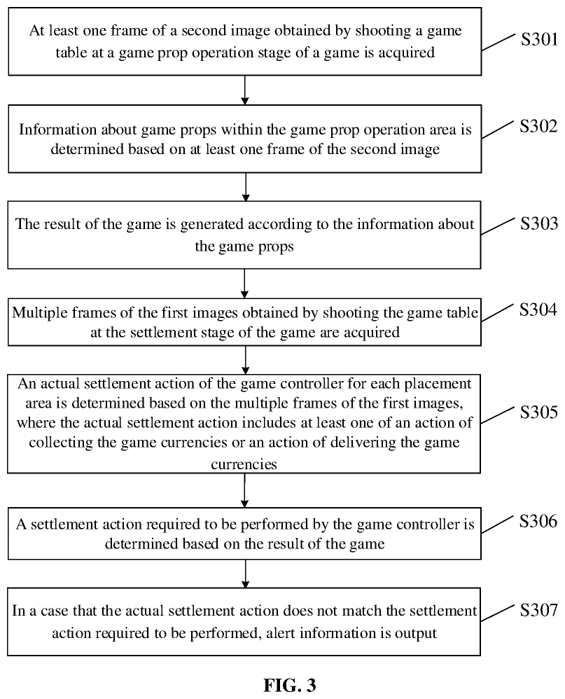

FIG. 3 is a flowchart of another alerting method according to an embodiment of the present disclosure. As shown in FIG. 3, the method is applied to an alerting apparatus. In the embodiment of the present disclosure, a game table further includes a game prop operation area. The method includes operations S301 to S307.

In S301, at least one frame of a second image obtained by shooting a game table at a game prop operation stage of a game is acquired.

The game prop operation stage may be a stage in which the game controller operates a game prop.

In some embodiments, at least one frame of the second image may be acquired through: receiving multiple frames of the second images which are obtained by shooting the game table with at least one camera mounted on a side and/or top of the game table and sent by the at least one camera. The sides of the game table may refer to the sides of the game currencies on the game table.

In other embodiments, the at least one frame of the second image may be acquired through: receiving at least one video which is obtained by shooting the game table with at least one camera mounted on a side and/or top of the game table and sent by the at least one camera; and intercepting the multiple frames of second images from the at least one video.

In S302, information about game props within the game prop operation area is determined based on at least one frame of the second image.

The information about the game props may be information presented by the game prop. For example, in a case that the game played at the game table is a card game, the game prop is a card, and the alerting apparatus may determine that the information about the game props is at least one of card rank information or card suit information of the dealt card based on at least one frame of the second image.

In S303, the result of the game is generated according to the information about the game props.

In a case that the game is a card game, in the game prop operation stage, the game controller may continuously display the dealt cards, such that the alerting device may continuously obtain at least one of the card rank information or the card suit information of the displayed cards. After obtaining at least one of the card rank information or the card suit information of all the cards dealt by the game controller, the alerting device may determine the result of the game based on at least one of the card rank information or the card suit information of all the dealt cards.

In S304, multiple frames of the first images obtained by shooting the game table at the settlement stage of the game are acquired.

In some embodiments, the multiple frames of the first images may be acquired through: receiving the plurality of frames of the first images which are obtained by shooting the game table with at least one camera mounted on a side and/or top of the game table and sent by the at least one camera.

In other embodiments, the multiple frames of the first images may be acquired through: receiving at least one video which is obtained by shooting the game table with at least one camera mounted on a side and/or top of the game table and sent by the at least one camera; and intercepting the multiple frames of the first images from the at least one video.

In some embodiments, the at least one frame of the second image may be shot by a camera mounted on the top such that information about game props within the game prop operation area may be accurately shot by the camera mounted on the top. In some embodiments, at least one frame of the first image may be shot by a camera mounted on the side such that at least one of the quantity or total value of the game currencies in each placement area may be accurately shot by the camera mounted on the side. In other embodiments, the at least one frame of the first image may be shot by a camera mounted on the side and the top such that the value of uppermost game currency of each stack of game currencies in each placement area may be accurately shot by the camera mounted on the top, and the number of game currencies of each stack of game currencies in each placement area may be accurately shot by the camera mounted on the side, and therefore the alerting device may accurately obtain at least one of the quantity or the total value of the game currencies in each placement area.

In this manner, the camera sends the acquired image or video to the alerting apparatus, such that the alerting apparatus may obtain multiple frames of the first images, and may further detect the action of the game controller on the game table in real time, thereby enabling real-time detection of the action of the game controller.

In S305, an actual settlement action of the game controller for each placement area is determined based on the multiple frames of the first images Herein, the actual settlement action includes at least one of an action of collecting the game currencies or an action of delivering the game currencies.

In S306, a settlement action required to be performed by the game controller is determined based on the result of the game.

In S307, in a case that actual settlement action does not match the settlement action required to be performed, alert information is output.

In some embodiments, outputting the alert information may include outputting the alert information to a management system. In a case that the management system receives the alert information, an alert corresponding to the alert information may be transmitted.

The management system may be a means for alerting provided on the game table.

In some embodiments, the management system may be a display device provided on the game table, which may transmit an alert corresponding to the alert information after receiving the alert information. For example, the management system may transmit the alert corresponding to the alert information through displaying the alert information. In implementation, the management system may further transmit at least one of an alert vibration, an alert light, and an alert tone.

In other embodiments, the management system may include a control device and sub-devices corresponding to respective placement areas on the game table. Each sub-device may include at least one of a display device, a sound producing device, a light-emitting device, or a vibrating device.

In the implementation, the alert information may include or indicate the identifiers of one or more placement areas and the actual settlement action information of the game controller, such that the control device in the management system may control the operation of the sub-devices corresponding to the one or more placement areas based on the identifiers of the one or more placement areas and the actual settlement action information of the game controller in a case that the alert information is received. Herein, controlling the operation of the sub-devices corresponding to the one or more placement areas may include at least one of the following: controlling the display device corresponding to the one or more placement areas to display at least one of the actual settlement action information of the game controller or the alert cause; controlling the sound producing device corresponding to one or more placement areas to generate at least one of the alert tone, actual settlement action information of the game controller, or alert cause; controlling the light emitting device corresponding to the one or more placement areas to emit alert light; and controlling the vibrating device corresponding to the one or more placement areas to give alert vibrations. In some embodiments, in a case that the actual settlement action information is different, the alert tone may be different, or at least one of the color, the luminance or the flicker period of the alert light may be different, or the vibration frequency of the alert vibration may be different. Herein, the alert cause may be determined based on the actual settlement action information of the game controller.

In some embodiments, the display device may display not only the actual settlement action information of the game controller, but also the settlement action required to be performed by the game controller, thereby enabling the game controller to quickly understand the difference between the actual settlement action information and the settlement action required to be performed.

In this manner, the alerting apparatus may output alert information to the management system in a case that it is determined that the actual settlement action of the game controller is inconsistent with the settlement action required to be performed, such that the management system may transmit a corresponding alert, and the game controller may withdraw the actual settlement action that is inconsistent with the settlement action required to be performed based on the alert transmitted by the management system, thereby reducing the loss to the game venue or the player due to the erroneous action of the game controller.

In the embodiment of the disclosure, the information about the game props in the game prop operation area may be determined based on at least one frame of the second image obtained by shooting the game table at the game prop operation stage, and then the information about the game props on the game prop operation area is generated based on the information about the game props on the game prop operation area, such that the alerting device may determine, based on the result of the game, the settlement action required to be performed by the game controller, and further detect whether the action of the game controller complies with a specified requirement by determining whether the actual settlement action of the game controller matches the settlement action required to be performed.

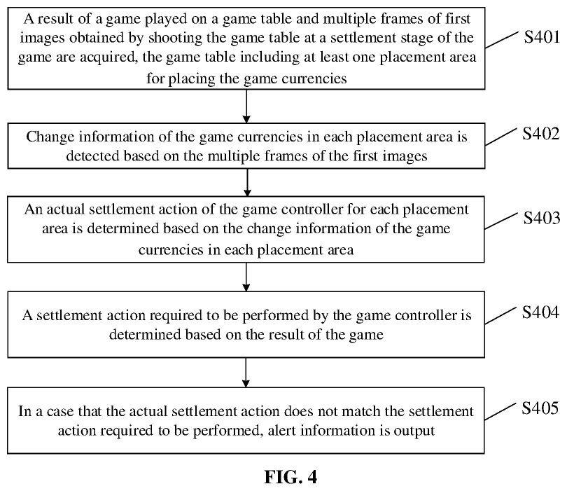

FIG. 4 is a flowchart of yet another alerting method according to an embodiment of the present disclosure. As shown in FIG. 4, the method is applied to an alerting apparatus. The method includes operations S401 to S405.

In S401, a result of a game played on a game table and multiple frames of first images obtained by shooting the game table at a settlement stage of the game are acquired. The game table includes at least one placement area for placing the game currencies.

In S402, change information of the game currencies in each placement area is detected based on the multiple frames of the first images.

In an embodiment of the present disclosure, at least one placement area of all the game currencies placement areas may include a first placement area and a second placement area. The first placement area may include one or more areas, the second placement area may include one or more areas, and the placement area corresponding to the first placement area does not coincide with the placement area corresponding to the second placement area.

The change information of the game currencies may include one of an increase in the number of the game currencies, a decrease in the number of the game currencies, an increase in the total value of the game currencies, or a decrease in the total value of the game currencies. Herein, a decrease in the number of the game currencies in a certain placement area or a decrease in the total value of the game currencies may include clearance of the game currencies in the certain placement area.

The embodiment of the present disclosure may provide a way to detect the change information of the game currencies in each placement area based on the multiple frames of the first images.

In some embodiments, the multiple frames of the first images may include at least one frame of a first sub-image, and at least one frame of a second sub-image shot after the at least one frame of a first sub-image. The alerting apparatus may determine a first attribute value of the game currencies in each placement area of the first sub-image. The attribute value includes at least one of the quantity or total value. The alerting apparatus may further determine a second attribute value of the game currencies in each placement area in the second sub-image, and determine the change information of the game currencies in each placement area based on the first attribute value of the game currencies and the second attribute value of the game currencies for a same placement area.

In some embodiments, the change information of the game currencies in each of the placed areas in the multiple frames of the first images may be detected continuously or in real time in the acquisition sequence of the multiple frames of the first images. The image acquired before the change of the game currencies is detected as the first sub-image, and the image acquired after the change of the game currencies is detected as the second sub-image.

In this embodiment, there are several placement areas where the game currencies are placed, and the alerting apparatus may determine the attribute value of the game currencies in each of the multiple placement areas based on at least one frame of the first sub-image. In a case that it is determined that the attribute value of the game currencies in any one or more placement area changes based on at least one frame of the second sub-image, the change information of the game currencies in each placement area is determined as: the game currencies in said any one or more placement areas are changed, while the game currencies in other placement areas other than said any one or more placement areas are not changed.

In some embodiments, when the first attribute value of the game currencies in the designated placement area among several placement areas where the game currencies are placed is less than the second attribute value of the game currencies, it is determined that the game currencies in the designated placement area increase. Herein, the first attribute value of the game currencies may be zero. And/or, when the first attribute value of the game currencies in the designated placement area is greater than the second attribute value of the game currencies in the designated placement area, it is determined that the game currencies in the designated placement area decrease. Herein, the second attribute value of the game currencies may be zero. It is determined that the game controller is to deliver the game currencies to the designated area in a case that the game currencies in the designated area increase; and/or, it is determined that the game controller is to collect the game currencies in the designated area in a case that the game currencies in the designated area decrease.

In this manner, based on at least one frame of the first sub-image and at least one frame of the second sub-image, it is possible to determine the change information of the game currencies in each placement area or more placement areas, and the change of the game currencies in a certain one or more placement areas, and further determine whether the game operator associated with the change of the game currencies is a game controller or not. In a case that the game operator is determined to be a game controller, it is possible to determine whether the action of the game controller conforms to regulations, thereby achieving the detection of the game behavior of the game controller.

In other embodiments, the multiple frames of the first images include at least one frame of a third sub-image, and at least one frame of a fourth sub-image shot after the at least one frame of the third sub-image. The alerting apparatus may determine that the game currencies in the predetermined placement area in each third sub-image are emptied. In a case that game currencies exists in the predetermined placement area of each fourth sub-image, and the attribute values of the game currencies are the same, the change information of the game currencies in each placement area is determined. Herein, the attribute values include at least one of the quantity or total value. The predetermined placement area may be the placement area of the winner or the placement area of the loser.

In some embodiments, the acquisition sequence for the multiple frames of the first images may be used to detect continuously or in real time whether or not the game currencies in the respective placement areas in the acquired multiple frames of first images are emptied. The first image before detecting that the game currencies in one of the placement areas are emptied is used as the third sub-image, and the first image after detecting that the game currencies in one of the placement areas are emptied is used as the fourth sub-image.

The predetermined placement area which is the placement area of the loser is taken as an example. In the implementation, in a case that the player determines that the placement area where the game currencies are placed is the placement area of the loser, then the game currencies are usually not placed in the placement area in the settlement stage of the game. Therefore, in a case that it is detected that the game currencies in the placement area of the loser are emptied and then increased, the alerting device may determine that it is the operation of the game controller. However, the operation of the game controller in the placement area of the loser, which makes that the game currencies are emptied and then increased, is not in accordance with the rules of the game and belongs to the category in which the game controller delivers the game currencies to the loser. Therefore, an alert is triggered. Or, it may be identified whether or not the hand appearing in the placement area of the loser belongs to the game controller, for example, a person's identity is identified based on a face associated with the hand, and then it is determined whether the game operator is the game controller, and when the game operator is determined to be the game controller, it is determined that it is the operation of the game controller that is performed on the placement area of the loser.

In this way, based on at least one frame of the third sub-image and at least one frame of the fourth sub-image, a situation is determined that the game currencies in the predetermined placement area are emptied and then increased, further the change information of the game currencies in each placement area is determined, and further it is determined that the actual settlement action of the game controller does not match the settlement action required to be performed.

In still other embodiments, the multiple frames of the first images include at least one frame of a fifth sub-image, and at least one frame of a sixth sub-image shot after the at least one frame of the fifth sub-image. The alerting apparatus may determine that in the fifth sub-image, a third attribute value of the game currencies in the first placement area corresponding to the player which is the winner, and a fourth attribute value of the game currencies in the second placement area corresponding to the player which is the loser. The attribute value includes at least one of the quantity or total value. The alerting apparatus may further determine, in the sixth sub-image, a fifth attribute value of the game currencies in the first placement area and a sixth attribute value of the game currencies in the second placement area. Based on the third attribute value of the game currencies, the fourth attribute value of the game currencies, the fifth attribute value of the game currencies and the sixth attribute value of the game currencies, the change information of the game currencies in each placement area is determined.

In some embodiments, the change in the attribute values of the game currencies in the first and second placement areas of the acquired plurality of frames of the first images may be detected continuously or in real time in the acquisition sequence for the multiple frames of the first images. The first image before detecting that the attribute values of the game currencies in at least one of the first placement area or the second placement area changes is used as the fifth sub-image, and the first image after detecting that the attribute values of the game currencies in at least one of the first placement area or the second placement area changes is used as the sixth sub-image.

In some embodiments, in a case that the fifth attribute value of the game currencies is larger than the third attribute value of the game currencies, and the fourth attribute value of the game currencies and the sixth attribute value of the game currencies are the same but not zero, the actual settlement action performed by the game controller not matching the settlement action required to be performed is determined as: an action of collecting parts of the game currencies in the placement area of the loser and delivering the game currencies in the placement area of the winner.

In this embodiment, based on the third attribute value of the game currencies, the fourth attribute value of the game currencies, the fifth attribute value of the game currencies and the sixth attribute value of the game currencies, it may be determined whether the game controller delivers the game currencies in the placement area of the winner after completing the collection of all the game currencies in the placement area of the loser.

In this manner, the attribute value of the game currencies in the placement area of each winner and the attribute value of the game currencies in the placement area of each loser may be determined on the basis of at least one frame of the fifth sub-image and at least one frame of the sixth sub-image. Therefore, through continuously detecting the attribute values of the game currencies in these two types of placement area, it is determined whether the game controller delivers the game currencies in the placement area of the winner after completing the collection of all the game currencies in the placement area of the loser. If not, an alert is generated to regulate the settlement action of the game controller.

In S403, an actual settlement action of the game controller for each placement area is determined based on the change information of the game currencies in each placement area.

In some embodiments, in a case that the change information of the game currencies in the first placement area is a decrease in at least one of the quantity or the total value of the game currencies, it is determined that the actual settlement action of the game controller in the first placement area is an action of collecting the game currencies.

In other embodiments, in a case that the change information of the game currencies in the second placement area is an increase in at least one of the quantity or the total value of the game currencies, it is determined that the actual settlement action of the game controller in the second placement area is an action of delivering the game currencies.

In some embodiments, the alerting method may further include determining, based on the multiple frames of the first images, a game currency operator associated with the change information of the game currencies in each placement area. Operation S403 may be implemented by: determining the actual settlement action of the game controller in each placement area based on the change information of the game currencies in each placement area, in a case that the game currency operator is the game controller.

The game currency operator may be any person at the side of the game table. For example, the game currency operator may be a game controller or any player at the side of the game table.

In the implementation, the alerting apparatus may determine the actual settlement action of the game controller for each placement area based on the change information of the game currencies in each placement area and the situation that the game operator associated with the change information of the game currencies in each placement area is the game controller. For example, the alerting device determines the actual settlement action of the game controller for a certain placement area in a case that the change in the game currencies in the certain placement area is detected and the game currency operator associated with the change in the game currencies is determined to be the game controller.

Thus, by determining the game currency operator associated with the change information of the game currencies in each placement area, the alerting device may determine the actual settlement action of the game controller for each placement area in a case that the game currency operator associated with the change of the game currencies in each placement area is the game controller, and may further determine accurately whether the actual settlement action matches the settlement action required to be performed, so as to achieve the accurate alert.

In S404, a settlement action required to be performed by the game controller is determined based on the result of the game.

In S405, in a case that the actual settlement action does not match the settlement action required to be performed, alert information is output.

In the embodiment of the present disclosure, the actual settlement action of the game controller for each placement area is determined based on the change information of the game currencies in each placement area, such that the alerting device may obtain the actual settlement action of the game controller for the placement area in a case that the game currencies in each placement area change, and further enable the detection of the actual settlement action of the game controller for each placement area, thereby making the detected actual settlement action of the game controller to be more targeted.

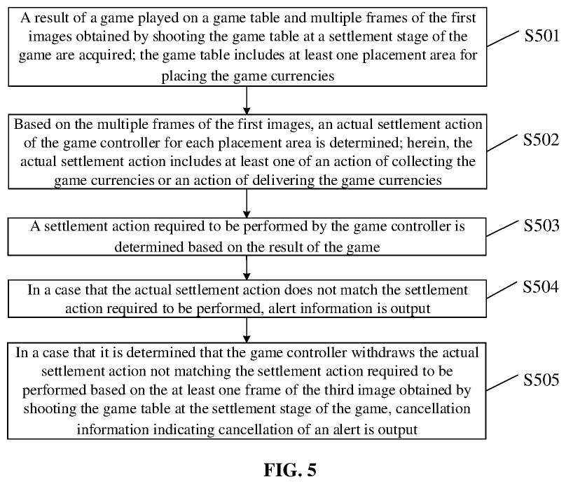

FIG. 5 is a flowchart of yet another alerting method according to an embodiment of the present disclosure. As shown in FIG. 5, the method is applied to an alerting apparatus. The method includes operations S501 to S505.

In S501, a result of a game played on a game table and multiple frames of the first images obtained by shooting the game table at a settlement stage of the game are acquired. The game table includes at least one placement area for placing the game currencies.

In S502, an actual settlement action of the game controller for each placement area is determined based on the multiple frames of the first images Herein, the actual settlement action includes at least one of an action of collecting the game currencies or an action of delivering the game currencies.

In S503, a settlement action required to be performed by the game controller is determined based on the result of the game.

In S504, in a case that the actual settlement action does not match the settlement action required to be performed, alert information is output.

In S505, in a case that it is determined that the game controller withdraws the actual settlement action not matching the settlement action required to be performed based on the at least one frame of the third image obtained by shooting the game table at the settlement stage of the game, the cancellation information indicating cancellation of an alert is output.

For example, in a case that the alerting apparatus determines that the action of the game controller of collecting the game currencies in a certain area is an actual settlement action not matching the settlement action required to be performed by the game controller, if it is determined that the game controller returns the collected game currencies in the area based on the at least one frame of the third image, then it is determined that the game controller withdraws the actual settlement action not matching the settlement action required to be performed. For another example, in a case that the alerting apparatus determines that the action of the game controller of delivering the game currencies in a certain area is an actual settlement action not matching the settlement action required to be performed by the game controller, if it is determined that the game controller withdraws the action of delivering the game currencies in the area based on the at least one frame of the third image, then it is determined that the game controller withdraws the actual settlement action not matching the settlement action required to be performed by the game controller.

In some embodiments, outputting the cancellation information indicating the cancellation of the alert may include outputting the cancellation information indicating the cancellation of the alert to a management system. In this way, in a case that the management system receives the cancellation information, the ongoing alert corresponding to the alert information is stopped or cancelled.

In some embodiments, in a case that the display device displays at least one of the actual settlement action information or the alert cause, the display device may stop displaying or no longer display at least one of the actual settlement action information or the alert cause based on the cancellation information. In other embodiments, in a case that the sound producing device generates the alert tone or the alert cause, the sound producing device may cause the sound producing device to stop generating the alert tone or the alert cause based on the cancellation information. In still other embodiments, in a case that the light emitting device emits the warning light, the light emitting device may stop the light emitting device from emitting the warning light based on the cancellation information. In still other embodiments, in a case that the vibrating device generates an alert vibration, the vibrating device may cause the vibrating device to stop generating the alert vibration based on the cancellation information.

In the embodiment of the present disclosure, after the alert information indicating the alert is output, and in a case that it is determined that the game controller withdraws the actual settlement action not matching the settlement action required to be performed based on at least one frame of the third image subsequently shot, the cancellation information indicating the cancellation of the alert may be further output to stop the alert, such that the game may be continued.

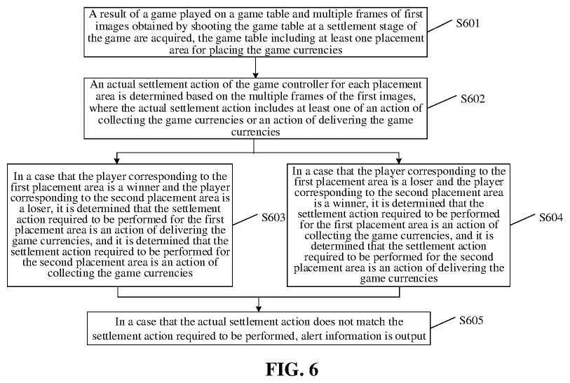

FIG. 6 is a flowchart of an alerting method according to another embodiment of the present disclosure. As shown in FIG. 6, the method is applied to an alerting apparatus. In the embodiment of the present disclosure, at least one placement area includes a first placement area and a second placement area, and a result of a game includes a result of a winning/losing determination result between a player corresponding to the first placement area and a player corresponding to the second placement area. The method includes operations S601 to S605.

In S601, a result of a game played on a game table and multiple frames of first images obtained by shooting the game table at a settlement stage of the game are acquired. The game table includes at least one placement area for placing the game currencies.

In S602, an actual settlement action of the game controller for each placement area is determined based on the multiple frames of the first images. Herein, the actual settlement action includes at least one of an action of collecting the game currencies or an action of delivering the game currencies.

In S603, in a case that the player corresponding to the first placement area is a winner and the player corresponding to the second placement area is a loser, it is determined that the settlement action required to be performed for the first placement area is an action of delivering the game currencies, and it is determined that the settlement action required to be performed for the second placement area is an action of collecting the game currencies.

Based on the operation S603, it may be determined that the settlement action required to be performed by the game controller includes collecting the game currencies in the second placement area, and delivering the game currencies in the first placement area after collection of the game currencies in the second placement area completes.

In S604, in a case that the player corresponding to the first placement area is a loser and the player corresponding to the second placement area is a winner, it is determined that the settlement action required to be performed for the first placement area is an action of collecting the game currencies, and it is determined that the settlement action required to be performed for the second placement area is an action of delivering the game currencies.

Based on the operation S604, it may be determined that the settlement action required to be performed by the game controller includes collecting the game currencies in the first placement area and delivering the game currencies in the second placement area after the collecting of the game currencies in the first placement area is completed.

In S605, in a case that the actual settlement action does not match the settlement action required to be performed, alert information is output.

In the embodiment of the present disclosure, since the result of the game includes a winning/losing determination result between the player corresponding to the first placement area and the player corresponding to the second placement area, it is possible to determine, according to the result of the game, the settlement action required to be performed by the game controller for the first placement area and the second placement area, and further to detect whether the actual settlement action of the game controller matches the settlement action required to be performed on the basis of the settlement action required to be performed, thereby standardizing the action of collecting the game currencies and the action of delivering the game currencies of the game controller.

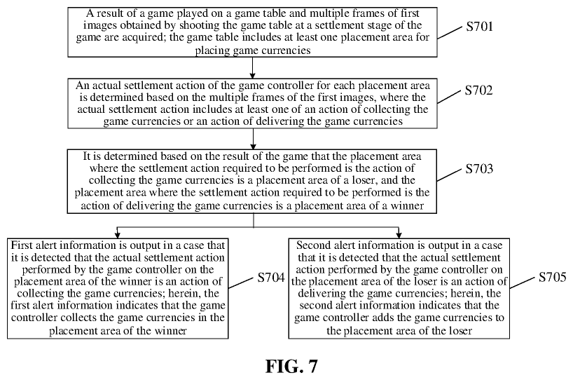

FIG. 7 is a flowchart of an alerting method according to still another embodiment of the present disclosure. As shown in FIG. 7, the method is applied to an alerting apparatus. The method includes operations S701 to S705.

In S701, a result of a game played on a game table and multiple frames of first images obtained by shooting the game table at a settlement stage of the game are acquired. The game table includes at least one placement area for placing game currencies.

In S702, an actual settlement action of the game controller for each placement area is determined based on the multiple frames of the first images. Herein, the actual settlement action includes at least one of an action of collecting the game currencies or an action of delivering the game currencies.

In S703, it is determined based on the result of the game that the placement area where the settlement action required to be performed is the action of collecting the game currencies is a placement area of a loser, and the placement area where the settlement action required to be performed is the action of delivering the game currencies is a placement area of a winner.

In implementation, the settlement action required to be performed by the game controller includes an action of collecting the game currencies in the placement area of each loser and an action of delivering the game currencies in the placement area of each winner. In some embodiments, the settlement action required to be performed by the game controller may further include: delivering the game currencies in the placement area of each winner sequentially only after collection of the game currencies in the placement area of each loser completes sequentially.

In S704, first alert information is output in a case that it is detected that the actual settlement action performed by the game controller on the placement area of the winner is an action of collecting the game currencies. Herein, the first alert information indicates that the game controller collects the game currencies in the placement area of the winner.

In a case that the actual settlement action performed by the game controller on the placement area of the winner is an action of collecting the game currencies, the attribute value of the game currencies in the placement area of the winner is reduced or cleared, and the attribute value of the game currencies includes at least one of the quantity or the total value.

In some embodiments, the alerting apparatus may detect that the actual settlement action performed by the game controller on the placement area of the winner is the action of collecting the game currencies in the following way: in a case that it is determined that at least one of the number or the total value of the game currencies in the placement area of the winner is reduced or cleared, and the game operator associated with the change in the game currencies of the placement area of the winner is the game controller, then it is determined that the actual settlement action performed by the game controller on the placement area of the winner is the action of collecting the game currencies.

In some embodiments, the alerting device may first acquire at least one frame of the first sub-image, and determine the attribute value of the game currencies in the placement area of each winner in each first sub-image; then acquire at least one frame of the second sub-image, determine the attribute value of the game currencies in the placement area of a certain winner in each second sub-image, which is less than the attribute value of the game currencies in the placement area of the certain winner in the first sub-image; and thus the alerting device may determine the reduction of the game currencies in the placement area of the certain winner in the first sub-image, and determine that the game controller collects the game currencies in the placement area of the winner. In some embodiments, the alerting device may further determine at least one frame of a designated image which is shot after at least one frame of the first sub-image and before at least one frame of the second sub-image, and determine, based on at least one frame of the designated image, that a game operator associated with a reduction in the game currencies in the placement area of the certain winner is a game controller. For example, in a case that a game currency collection device or the game controller's hand appears in each of the at least one frame of the designated image, the alerting device determines that the game controller collects the game currencies in the placement area of the winner.

In some embodiments, outputting the first alert information may include outputting the first alert information to a management system. In this way, in a case that the management system receives the first alert information, an alert may be made that indicates collecting the game currencies in the placement area of the winner.

In S705, second alert information is output, in a case that it is detected that the actual settlement action performed by the game controller on the placement area of the loser is an action of delivering the game currencies. Herein, the second alert information indicates that the game controller adds game currencies to the placement area of the loser.

There are two ways to determine that a game controller delivers game currencies to a placement area of a loser.

In one embodiment, in a case that an increase in the game currencies in the placement area of the loser is detected, it is determined that the game controller delivers the game currencies to the placement area of the loser.

The alerting device may determine that the game controller delivers the game currencies to the placement area of the loser in a case that an increase in the game currencies in the placement area of the loser is detected and the game operator associated with the increase in the game currencies is the game controller.

In some embodiments, the alerting device may first acquire at least one frame of the first sub-image, and determine the attribute value of the game currencies in the placement area of each loser in each first sub-image; and then acquire at least one frame of the second sub-image, and determine the attribute value of the game currencies in the placement area of a certain loser in each second sub-image, which is greater than the attribute value of the game currencies in the placement area of the certain loser in the first sub-image; and thus the alerting device may determine the increase of the game currencies in the placement area of the certain loser. In some embodiments, the alerting device may further determine at least one frame of a designated image which is shot after at least one frame of the first sub-image and before at least one frame of the second sub-image, and determine, based on at least one frame of the designated image, that a game operator associated with an increase in the game currencies in the placement area of the certain loser is a game controller. For example, in a case that a game currency collection device or the game controller's hand appears in each of the at least one frame of the designated image, the alerting device determines that the game controller delivers the game currencies in the placement area of the loser.

In other embodiments, it is determined that the game controller delivers the game currencies to the placement area of the loser in a case that it is detected that the game currencies in the placement area of the loser are emptied and then increased.

In some embodiments, the alerting device may first acquire at least one frame of the third sub-image, and determine that the attribute value of the game currencies in the placement area of each winner and/or loser in each third sub-image is zero; and then acquire at least one frame of the fourth sub-image, and determine that the game currencies are present in a certain placement area (which may be the placement area of the winner or loser) and the number of the game currencies is the same; and further determine that the game currencies in the certain placement area are emptied and then increased, and determine that the game controller adds the game currencies to the certain placement area after the game currencies in the certain placement area are emptied. In some embodiments, the alerting device may further determine at least one frame of a specific image shot after at least one frame of the third sub-image and before at least one frame of the fourth sub-image, and determine, based on at least one frame of the specific image, that the game currencies in the certain placement area are emptied and then increased, and the associated game operator is a game controller. For example, in a case that a game currency collection device or the game controller's hand appears in each of the at least one frame of the designated image, the alerting device determines that the game controller adds the game currencies to the certain placement area after the game currencies in the certain placement area are emptied.

In some embodiments, the alerting apparatus may output the second alert information in a case that an increase in the number of game currencies in the placement area of the loser is detected.

In other embodiments, the alerting apparatus may output the second alert information in a case that the game currencies in the placement area of the loser are emptied and then increased.

The alerting device may further acquire at least one frame of the seventh sub-image shot after the at least one frame of the second sub-image, such that the alerting device may further detect, based on at least one frame of the seventh sub-image, that the game controller withdraws the settlement action. This may be implemented in the following way.

After outputting the first alert information, in a case that it is detected that action of withdrawing the settlement action by the game controller on the placement area of the winner is the withdrawing of the action of collecting the game currencies, the first cancellation information is output. The first cancellation information indicates that the alert corresponding to the first alert information is cancelled.

After outputting the second alert information, in a case that it is detected that action of withdrawing the settlement action by the game controller on the placement area of the loser is the withdrawing of the action of delivering the game currencies, the second cancellation information is output. The second cancellation information indicates that the alert corresponding to the second alert information is cancelled.

In some embodiments, outputting the first cancellation information/the second cancellation information may include outputting the first cancellation information/the second cancellation information to the management system. In the implementation, the first cancellation information/the second cancellation information may include or indicate an identifier of the placement area corresponding to the alert. In this way, in a case that the management system receives the first cancellation information, the alert may be stopped for the placement area corresponding to the alert.

In the embodiment of the present disclosure, after outputting the first alert information, and based on at least one frame of the seventh sub-image subsequently shot, the first cancellation information may be outputted in a case that it is determined that the game controller withdraws the action of collecting the game currencies in the placement area of the winner, and the second cancellation information may be outputted in a case that it is determined that the game controller withdraws the action of delivering the game currencies to the placement area of the loser, so as to stop the alert and enable the game to continue.

In this way, the game controller delivers the game currencies in the placement area of the loser in two erroneous modes. In the first mode, the game controller delivers the game currencies to the placement area of the loser in a case that the game currencies exist in the placement area of the loser. In the second mode, the game controller collects the game currencies in the placement area of the loser and then delivers the game currencies to the placement area of the loser. In addition, two erroneous actions of the game controller that do not match the settlement action required to be performed by the game controller may be detected, and an alert may be given upon the detection, and therefore, the game controller is prompted through the alert to deliver the game currencies in the placement area of the loser, thereby reducing the loss to the game venue.

In the embodiment of the disclosure, the first alert information is outputted in a case that it is detected that the actual settlement action performed by the game controller on the placement area of the winner is the action of collecting the game currencies, and the second alert information is outputted in a case that it is detected that the actual settlement action performed by the game controller on the placement area of the loser is the action of delivering the game currencies. Thus, the alert may be outputted in a case that it is detected that the game controller makes an action not matching the settlement action required to be performed, thereby improving the standardization of the action of the game controller.

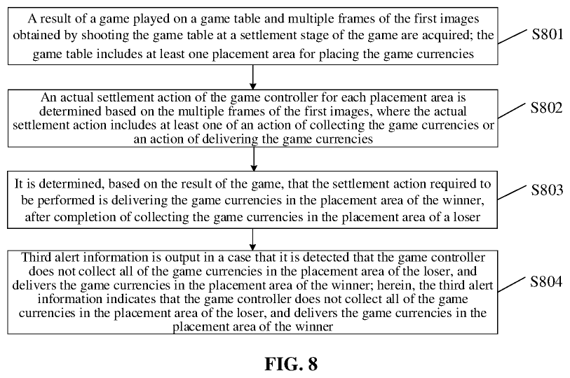

FIG. 8 is a flowchart of an alerting method according to still another embodiment of the present disclosure. As shown in FIG. 8, the method is applied to an alerting apparatus. The method includes operations S801 to S804.

In S801, a result of a game played on a game table and multiple frames of the first images obtained by shooting the game table at a settlement stage of the game are acquired. The game table includes at least one placement area for placing the game currencies.

In S802, an actual settlement action of the game controller for each placement area is determined based on the multiple frames of the first images Herein, the actual settlement action includes at least one of an action of collecting the game currencies or an action of delivering the game currencies.

In S803, it is determined, based on the result of the game, that the settlement action required to be performed is delivering the game currencies in the placement area of the winner, after completion of collecting the game currencies in the placement area of a loser.

In S804, third alert information is output, in a case that it is detected that the game controller does not collect all of the game currencies in the placement area of the loser, and delivers the game currencies in the placement area of the winner. Herein, the third alert information indicates that the game controller does not collect all of the game currencies in the placement area of the loser, and delivers the game currencies in the placement area of the winner.

In some embodiments, outputting the third alert information may include outputting the third alert information to the management system. In implementation, the content indicated by the third alerting device is the detection of game currencies in an area corresponding to the loser. The third alerting device may further indicate an identifier of a placement area where the game currencies of the loser are not collected, and an identifier of a placement area where the game currencies of the winner are delivered. Thus, in some embodiments, in a case that the alerting device receives the third alert information, an alert may be given to indicate that the game currencies in the area corresponding to the loser are detected based on at least one of the placement area where the game currencies of the loser are not collected and the placement area where the game currencies of the winner are delivered.

In some embodiments, the alerting device may first acquire at least one frame of the fifth sub-image, and determine the third attribute value of the game currencies in the first placement area of the winner in any fifth sub-image and the fourth attribute value of the game currencies in the second placement area of the loser; and then acquire at least one frame of the sixth sub-image, and determine the fifth attribute value of the game currencies in the first placement area of any sixth sub-image and the sixth attribute value of the game currencies in the second placement area; and in a case that both the fourth attribute value of the game currencies and the sixth attribute value of the game currencies are zero, and the fifth attribute value of the game currencies is greater than the third attribute value of the game currencies, it is determined that the game currencies in the placement area of the winner are delivered after the game currencies in the placement area of the loser are emptied. In a case that the sixth attribute value of the game currencies is smaller than the fourth attribute value of the game currencies, and the fifth attribute value of the game currencies is the same as the third attribute value of the game currencies, it is determined that the game currencies in the placement area of the loser are being collected.

However, in a case that neither the sixth attribute value of the game currencies nor the fourth attribute value of the game currencies is zero, and the fifth attribute value of the game currencies is greater than the third attribute value of the game currencies, it is determined that the game currencies in the placement area of the winner are delivered after not all of the game currencies in the placement area of the loser are collected. The action of the game controller does not match the settlement action required to be performed, and the alerting device may output the third alert information.

In some embodiments, the multiple frames of the first images further includes at least one frame of an eighth sub-image shot after at least one frame of the sixth sub-image. The alerting device may further perform the follow operations: detecting the withdrawing of the settlement action of the game controller based on at least one frame of the eighth sub-image; after outputting the third alert information, in a case that it is detected that the game controller withdraws the action of delivering the game currencies in the placement area of the winner, the third cancellation information is outputted. The third cancellation information indicates the cancellation of an alert corresponding to the third alert information to stop the alert, such that the game may be continued.

In an embodiment of the present disclosure, in a case that it is determined that the game controller does not collect at least one game currency in the placement area of the loser, and the game currencies in the placement area of the winner are delivered, the third alert information is output. Therefore, the game controller may withdraw the action of delivering the game currencies in the placement area of the winner according to the alert, thereby not only standardizing the flow of actions of the game controller, but also accurately giving an alert on the situation that the game controller delivers the game currencies in the placement area of the winner multiple times and further causes loss to the game venue.

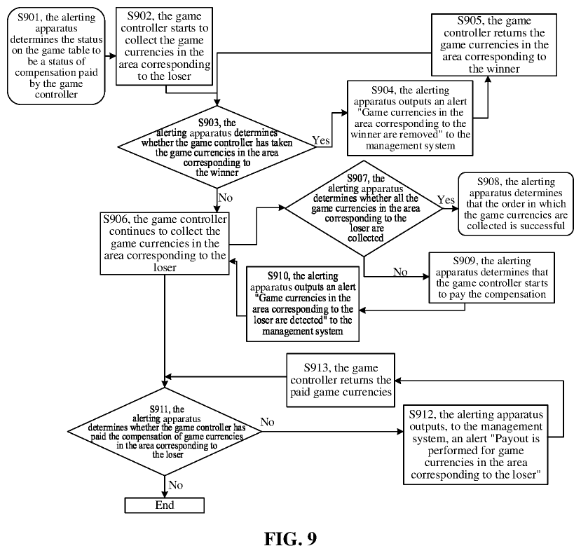

FIG. 9 is a flowchart of another alerting method according to still another embodiment of the present disclosure. As shown in FIG. 12, the method includes operations S901 to S913.

In S901, the alerting apparatus determines the status on the game table to be a status of payout by the game controller.

The status of payout by the game controller may be a status of the game controller at the settlement stage of the game.

In S902, the game controller starts to collect the game currencies in the area corresponding to the loser.

The output game currencies may correspond to the game currencies in the placement area of the loser described above.

In S903, the alerting apparatus determines whether the game controller has taken the game currencies in the area corresponding to the winner.

The game currencies in the area corresponding to the winner may correspond to the game currencies in the placement area of the winner described above.

When the determination is positive, the flow proceeds to S904. When the determination is negative, the flow proceeds to S906.

In S904, the alerting apparatus outputs an alert “Game currencies in the area corresponding to the winner are removed” to the management system.

In S905, the game controller returns the game currencies in the area corresponding to the winner.

After S905, the method proceeds to S903.

In S906, the game controller continues to collect the game currencies in the area corresponding to the loser.

In S907, the alerting apparatus determines whether all the game currencies in the area corresponding to the loser are collected.

When the determination is positive, the flow proceeds to S908. When the determination is negative, the flow proceeds to S909.

In S908, the alerting apparatus determines that the order in which the game currencies are collected is successful.

In S909, the alerting apparatus determines that the game controller starts to perform payout.

In S910, the alerting apparatus outputs an alert “Game currencies in the area corresponding to the loser are detected” to the management system.

After S910, the flow may proceed to S906.

In S911, the alerting apparatus determines whether the game controller performs payout for game currencies in the area corresponding to the loser.

When the determination is positive, the flow proceeds to S912. When the determination is negative, the flow ends.

In S912, the alerting apparatus outputs, to the management system, an alert “Payout is performed for game currencies in the area corresponding to the loser”.

In S913, the game controller returns the paid game currencies.

In an embodiment of the present disclosure, the alerting apparatus is turned on, the player places the game currencies, and before the result of the game occurs, the alerting apparatus may analyze the acquired real-time image to determine that the game currencies on the game table are increasing. After the result of the game appear on the game table, the alerting apparatus may detect the game currencies based on the acquired at least one frame of the first image and determine that the game currencies in each area are the game currencies in the area corresponding to the loser or the game currencies in the area corresponding to the winner. Thereafter, the alerting apparatus may determine whether the game controller performs the take pay action according to a normal flow based on the game currency data (such as the number of the game currencies and/or the value of the game currencies) in at least one frame of a second image shot after at least one frame of the first image. When the determination is negative, an alert is triggered. For example, when the game controller directly performs payout for the game currencies in the placement area of the loser, the alert “Payout is performed for game currencies in the area corresponding to the loser” is sent. For another example, when it is detected that the game currencies in the area corresponding to the loser are not all collected and payout is performed for the game currencies in the area corresponding to the winner, the alert “Game currencies in the area corresponding to the loser are detected” is sent. For another example, in a case that it is detected that the game currencies in the area corresponding to the winner are collected, the alert “Game currencies in the area corresponding to the winner are removed” is sent. In a case that the game controller performs the take pay action according to the normal flow, no alert is sent.

In an embodiment of the present disclosure, analyzing any image by the alerting apparatus may include analyzing any image by the parsing layer of the alerting apparatus.

Based on the foregoing embodiments, an embodiment of the present disclosure provides a device for controlling a mode. Each unit included in the device and each module included in each unit may be implemented by a processor in an alerting apparatus, or may be implemented by a specific logic circuit.

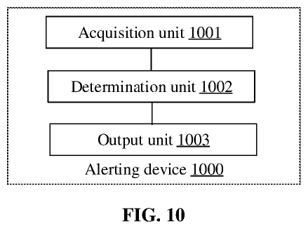

FIG. 10 is a structural diagram of an alerting device according to an embodiment of the present disclosure. As shown in FIG. 10, the alerting device 1000 includes an acquisition unit 1001, a determination unit 1002, and an output unit 1003.

The acquisition unit 1001 is configured to acquire a result of a game played at a game table and multiple frames of first images obtained by shooting the game table at a settlement stage of the game. The game table includes at least one placement area for placing game currencies.

The determination unit 1002 is configured to determine, based on the multiple frames of the first images, an actual settlement action of a game controller for each placement area, and determine, based on the result of the game, a settlement action required to be performed by the game controller. Herein, the actual settlement action includes at least one of an action of collecting the game currencies or an action of delivering the game currencies.

The output unit 1003 is configured to output alert information in a case that the actual settlement action does not match the settlement action required to be performed.

In some embodiments, the game table further includes a game prop operation area. The acquisition unit 1001 is further configured to obtain at least one frame of a second image obtained by shooting the game table at a game prop operation stage of the game; determine information about game props within the game prop operation area based on the at least one frame of the second image; and generate the result of the game according to the information about the game props.

In some embodiments, the determination unit 1002 is further configured to detect change information of the game currencies in each placement area based on the multiple frames of the first images; and determine the actual settlement action of the game controller in each placement area based on the change information of the game currencies in each placement area.

In some embodiments, the determination unit 1002 is further configured to determine, based on the multiple frames of the first images, a game currency operator associated with the change information of the game currencies in each placement area; and determine the actual settlement action of the game controller in each placement area based on the change information of the game currencies in each placement area, in a case that the game currency operator is the game controller.

In some embodiments, the acquisition unit 1001 is further configured to receive the plurality of frames of the first images which are obtained by shooting the game table with at least one camera mounted on a side and/or top of the game table and sent by the at least one camera.

In some embodiments, the acquisition unit 1001 is further configured to receive at least one video which is obtained by shooting the game table with at least one camera mounted on a side and/or top of the game table and sent by the at least one camera, and intercept the plurality of frames of the first images from the at least one video.

In some embodiments, the output unit 1003 is further configured to output the alert information to a management system.

In some embodiments, the output unit 1003 is further configured to output cancellation information indicating cancellation of an alert, in a case that it is determined that the game controller withdraws an actual settlement action not matching the settlement action required to be performed based on at least one frame of a third image obtained by shooting the game table at the settlement stage of the game.

In some embodiments, the at least one placement area includes a first placement area and a second placement area, and the result of the game includes a winning/losing determination result between a player corresponding to the first placement area and a player corresponding to the second placement area. The determination unit 1002 is further configured to: determine that the settlement action required to be performed in the first placement are is the action of delivering the game currencies, and determine that the settlement action required to be performed in the second placement area is the action of collecting the game currencies, in a case that the player corresponding to the first placement area is a winner and the player corresponding to the second placement area is a loser; determine that the settlement action required to be performed in the first placement are is the action of collecting the game currencies, and determine that the settlement action required to be performed in the second placement area is the action of delivering the game currencies, in a case that the player corresponding to the first placement area is a loser and the player corresponding to the second placement area is a winner.

In some embodiments, the determination unit 1002 is further configured to determine, based on the result of the game, that a placement area where the settlement action required to be performed is the action of collecting the game currencies is the placement area of a loser, and a placement area where the settlement action required to be performed is the action of delivering the game currencies is the placement area of a winner. The output unit 1003 is further configured to output first alert information in a case that it is detected that the actual settlement action performed by the game controller on the placement area of the winner is the action of collecting the game currencies; wherein the first alert information indicates that the game controller collects the game currencies in the placement area of the winner; and/or output second alert information in a case that it is detected that the actual settlement action performed by the game controller on the placement area of the loser is the action of delivering the game currencies; wherein the second alert information indicates that the game controller increases the game currencies in the placement area of the loser.

In some embodiments, the determination unit 1002 is further configured to determine, based on the result of the game, that the settlement action required to be performed is delivering the game currencies in the placement area of the winner, after completion of collecting the game currencies in the placement area of a loser. The output unit 1003 is further configured to output third alert information, in a case that it is detected that the game controller does not collect all of the game currencies in the placement area of the loser and delivers the game currencies in the placement area of the winner; wherein the third alert information indicates that the game controller does not collect all of the game currencies in the placement area of the loser and delivers the game currencies in the placement area of the winner.

In some embodiments, the multiple frames of the first images include at least one frame of a first sub-image and at least one frame of a second sub-image shot after the at least one frame of the first sub-image. The determination unit 1002 is further configured to determine a first attribute value of the game currencies in each placement area in the first sub-image, the attribute value including at least one of a quantity or a total value; and determine a second attribute value of the game currencies in each placement area in the second sub-image; and determine the change information of the game currencies in each placement area based on the first attribute value of the game currencies and the second attribute value of the game currencies for a same placement area.

In some embodiments, the multiple frames of the first images include at least one frame of the third sub-image, and at least one frame of the fourth sub-image shot after the at least one frame of the third sub-image. The determination unit 1002 is further configured to determine that the game currencies in a predetermined placement area in each of the third sub-image are emptied; and determine the change information of the game currencies in each placement area, in a case that a game currencies exists in the predetermined placement area of each of the fourth sub-image and attribute values of the game currencies are the same. Herein, the attribute values include at least one of a quantity or a total value.

In some embodiments, the multiple frames of the first images include at least one frame of the fifth sub-image, and at least one frame of the sixth sub-image shot after the at least one frame of the fifth sub-image. The determination unit 1002 is further configured to determine, in the fifth sub-image, a third attribute value of the game currencies in a first placement area corresponding to which a player is a winner and a fourth attribute value of the game currencies in a second placement area corresponding to which a player is a loser; the attribute value including at least one of a quantity or a total value; determine, in the sixth sub-image, a fifth attribute value of the game currencies in the first placement area and a sixth attribute value of the game currencies in the second placement area; and determine the change information of the game currencies in each placement area based on the third attribute value of the game currencies, the fourth attribute value of the game currencies, the fifth attribute value of the game currencies and the sixth attribute value of the game currencies.

The description of the abovementioned device embodiments is similar to that of the abovementioned method embodiments, and has a beneficial effect similar to that of the method embodiments. For technical details not disclosed in the device embodiments of the disclosure, references may be made to the description of the disclosed method embodiments.

It should be noted that in the embodiment of the disclosure, when the alerting method described above is implemented in the form of a software function module and sold or used as a stand-alone product, it may be further stored in a computer-readable storage medium. Based on such an understanding, the technical solution of the embodiments of the present disclosure, or portions thereof contributing to the related art, may be embodied in the form of a software product stored in a storage medium including instructions for causing a device to perform all or parts of the methods of the embodiments of the present disclosure. The storage medium includes a medium capable of storing program codes, such as a USB flash drive, a removable hard disk, a Read Only Memory (ROM), a magnetic disk, or an optical disk. Thus, the embodiments of the disclosure are not limited to any particular combination of hardware and software.

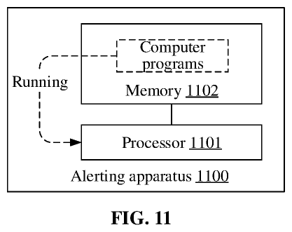

FIG. 11 is a schematic diagram of a hardware entity of an alerting apparatus according to an embodiment of the present disclosure. As shown in FIG. 11, the hardware entity of the alerting apparatus 1100 includes a processor 1101 and a memory 1102. Herein, the memory 1102 stores computer programs that may run on the processor 1101, and the processor 1101 implements the operations of the method of any of the abovementioned embodiments when executing the programs. In some embodiments, the alerting apparatus 1100 may be the alerting apparatus illustrated in any of the embodiments described above.

The memory 1102 stores computer programs executable by the processor. The memory 1102 is configured to store instructions and applications executable by the processor 1101, and may further cache data (e.g., image data, audio data, voice communication data, and video communication data) to be processed or already processed by modules in the processor 1101 and the alerting apparatus 1100. The memory 1102 may be implemented by a flash memory (FLASH) or a Random Access Memory (RAM).

The processor 1101 implements the operations of the alerting method of any of the abovementioned when executing the programs. The processor 1101 generally controls the overall operation of the alerting apparatus 1100.

Embodiment of the present disclosure provides a computer storage medium storing one or more programs executable by one or more processors to implement the operations of the alerting method of any of the abovementioned embodiments.

It should be noted here that the above description of the storage medium and device embodiments is similar to the above description of the method embodiments, and has the advantages similar to the method embodiments. For technical details not disclosed in the storage medium and device embodiments of the disclosure, references may be made to the description of the method embodiments of the disclosure.

The processor may be at least one of a Application Specific Integrated Circuit (ASIC), a Digital Signal Processor (DSP), a Digital Signal Processing Device (DSPD), a Programmable Logic Device (PLD), a Field Programmable Gate Array (FPGA), a Central Processing Unit (CPU), a controller, a microcontroller, or a microprocessor. It is to be understood that other electronic devices implementing the above-described functions of the processor are possible, which are not specifically limited in the embodiments of the present disclosure.

The computer storage medium/memory may be a Read Only Memory (ROM), a Programmable Read-Only Memory (PROM), an Erasable Programmable Read-Only Memory (EPROM), an Electrically Erasable Programmable Read-Only Memory (EEPROM), a Ferromagnetic Random Access Memory (FRAM), a Flash Memory (Flash Memory), a magnetic surface memory, an optical disk, or a Compact Disc Read-Only Memory (CD-ROM). It may further be terminals including one of or any combination of the above-mentioned memories, such as a mobile phone, a computer, a tablet device, a personal digital assistant, or the like.

It is to be understood that reference throughout the specification to “one embodiment” or “an embodiment” or “an embodiment of the present disclosure” or “some embodiments” or “some embodiments” means that a particular feature, structure, or characteristic associated with the embodiment is included in at least one embodiment of the present disclosure. Thus, the reference to “in one embodiment” or “in a embodiment” or “the embodiment of the disclosures” or “the foregoing embodiments” or “some embodiments” throughout the specification are not necessarily referring to the same embodiment. Furthermore, these specific features, structures, or characteristics may be combined in any suitable manner in one or more embodiments. It is to be understood that, in the embodiments of the present disclosure, the values of the sequence numbers of the various processes described above do not mean the order of execution, and the order of execution of the various processes should be determined by their function and intrinsic logic, and should not constitute any limitation on the implementation of the embodiments of the present disclosure. The above-described serial numbers of the embodiments of the disclosures are for the purpose of description only and do not represent the advantages or disadvantages of the embodiments.

If not specifically described, the alerting apparatus performs any of the operations in the embodiments of the present disclosure, which may be performed by a processor of the alerting apparatus. Unless otherwise specified, the embodiments of the present disclosure do not limit the order in which the alerting apparatus performs the following operations. In addition, the manner in which the data is processed in different embodiments may be the same method or different methods. It should be further noted that any of the operations in the embodiments of the present disclosure may be independently performed by the alerting apparatus, that is, when the alerting apparatus performs any of the operations in the above embodiments, it may be independent of the execution of other operations.

In the several embodiments provided by the present disclosure, it is to be understood that the disclosed devices and methods may be implemented in other ways. The device embodiments described above are merely illustrative. For example, the partitioning of the units is only logical partitioning of the functions, and may be implemented in another manner of partitioning. For example, multiple units or components may be combined, or may be integrated into another system, or some features may be ignored, or not performed. In addition, the coupling, or direct coupling, or communication connection of the components shown or discussed with respect to each other may be through some interfaces, and the indirect coupling, or communication connection of devices or units may be electrical, mechanical, or in other forms.

The units described above as separate parts may or may not be physically separate, and the units shown as units may or may not be physical units. The units may be located at one location or distributed across multiple network elements. Some or all of the elements may be selected according to actual needs to achieve the objectives of the embodiments.

In addition, the functional units in the embodiments of the present disclosure may be integrated into a single processing unit, or each unit may be a single unit separately, or two or more units may be integrated into a single unit. The integrated units may be implemented in the form of hardware or in the form of hardware plus software functional units.

The methods disclosed in the several method embodiments provided by the present disclosure may be combined arbitrarily without conflict to give new method embodiments.

The features disclosed in the several product embodiments provided by the present disclosure may be combined arbitrarily without conflict to obtain new product embodiments.

The features disclosed in the several method or device embodiments provided by the present disclosure may be combined arbitrarily without conflict to obtain new method or device embodiments.

It is to be understood by those of ordinary skill in the art that all or parts of the operations of the above-described method embodiments may be carried out by means of hardware associated with program instructions. The above-described programs may be stored in a computer-readable storage medium. The programs, when executed, perform the operations of the above-described method embodiments. The storage medium includes mediums capable of storing program codes, such as a removable storage device, a Read Only Memory (ROM), a magnetic disk, or an optical disk.

Or, the above-described integrated units of the present disclosure may be further stored in a computer-readable storage medium when implemented in the form of software functional modules and sold or used as separate products. Based on such an understanding, the essence or the part contributing to the related art of the technical solution of the embodiments in the present disclosure may be embodied in the form of a software product stored in a storage medium. The storage medium includes instructions for causing a computer device (which may be a personal computer, an alerting apparatus, a network device, or the like) to perform all or parts of the methods described in the embodiments of the present disclosure. The above-mentioned storage medium includes various mediums capable of storing program codes, such as a removable storage device, a ROM, a magnetic disk, or an optical disk.

In the embodiments of the present disclosure, reference may be made to the description of the same operations and the same contents in different embodiments. In the embodiments of the present disclosure, the term “and” does not affect the order of the operations.

As described above, only the embodiments of the present disclosure are described, but the scope of protection of the present disclosure is not limited thereto. Variations or substitutions may readily occur to those skilled in the art within the technical scope of the present disclosure, and are intended to be included within the scope of protection of the present disclosure. Accordingly, the scope of protection of the present disclosure should in accordance with the scope of protection of the claims.

1. An alerting method, comprising:
acquiring a result of a game played at a game table and a plurality of frames of first images obtained by shooting the game table at a settlement stage of the game, the game table comprising at least one placement area for placing game currencies;
determining, based on the plurality of frames of the first images, an actual settlement action of a game controller for each placement area, wherein the actual settlement action comprises at least one of an action of collecting the game currencies or an action of delivering the game currencies;
determining, based on the result of the game, a settlement action required to be performed by the game controller; and
outputting alert information in a case that the actual settlement action does not match the settlement action required to be performed.

2. The method of claim 1, wherein the game table further comprises a game prop operation area, and acquiring the result of the game played at the game table comprises:
obtaining at least one frame of a second image obtained by shooting the game table at a game prop operation stage of the game;
determining information about game props within the game prop operation area based on the at least one frame of the second image; and
generating the result of the game according to the information about the game props.

3. The method of claim 1, wherein determining, based on the plurality of frames of the first images, the actual settlement action of the game controller for each placement area comprises:
detecting change information of the game currencies in each placement area based on the plurality of frames of the first images; and
determining the actual settlement action of the game controller in each placement area based on the change information of the game currencies in each placement area.

4. The method of claim 3, further comprising:
determining, based on the plurality of frames of the first images, a game currency operator associated with the change information of the game currencies in each placement area;
wherein determining the actual settlement action of the game controller in each placement area based on the change information of the game currencies in each placement area comprises:
in a case that the game currency operator is the game controller, determining the actual settlement action of the game controller in each placement area based on the change information of the game currencies in each placement area.

5. The method of claim 1, wherein the plurality of frames of the first images are acquired as follows:
receiving the plurality of frames of the first images which are obtained by shooting the game table with at least one camera mounted on a side and/or top of the game table and sent by the at least one camera; or
receiving at least one video which is obtained by shooting the game table with at least one camera mounted on a side and/or top of the game table and sent by the at least one camera, and intercepting the plurality of frames of the first images from the at least one video.

6. The method of claim 1, wherein outputting the alert information comprises outputting the alert information to a management system.

7. The method of claim 1, wherein after outputting the alert information, the method further comprises:
outputting cancellation information indicating cancellation of an alert, in a case that it is determined that the game controller withdraws an actual settlement action not matching the settlement action required to be performed based on at least one frame of a third image obtained by shooting the game table at the settlement stage of the game.

8. The method of claim 1, wherein the at least one placement area comprises a first placement area and a second placement area, and the result of the game comprises a winning/losing determination result between a player corresponding to the first placement area and a player corresponding to the second placement area; and
determining, based on the result of the game, the settlement action required to be performed by the game controller comprises:
in a case that the player corresponding to the first placement area is a winner and the player corresponding to the second placement area is a loser, determining that the settlement action required to be performed in the first placement are is the action of delivering the game currencies, and determining that the settlement action required to be performed in the second placement area is the action of collecting the game currencies; or
in a case that the player corresponding to the first placement area is a loser and the player corresponding to the second placement area is a winner, determining that the settlement action required to be performed in the first placement are is the action of collecting the game currencies, and determining that the settlement action required to be performed in the second placement area is the action of delivering the game currencies.

9. The method of claim 1, wherein determining, based on the result of the game, the settlement action required to be performed by the game controller comprises:
determining, based on the result of the game, that a placement area where the settlement action required to be performed is the action of collecting the game currencies is the placement area of a loser, and a placement area where the settlement action required to be performed is the action of delivering the game currencies is the placement area of a winner; and
outputting the alert information in a case that the actual settlement action does not match the settlement action required to be performed comprises at least one of:
outputting first alert information in a case that it is detected that the actual settlement action performed by the game controller on the placement area of the winner is the action of collecting the game currencies; wherein the first alert information indicates that the game controller collects the game currencies in the placement area of the winner; or
outputting second alert information in a case that it is detected that the actual settlement action performed by the game controller on the placement area of the loser is the action of delivering the game currencies; wherein the second alert information indicates that the game controller increases the game currencies in the placement area of the loser.

10. The method of claim 1, wherein determining, based on the result of the game, the settlement action required to be performed by the game controller comprises:
determining, based on the result of the game, that the settlement action required to be performed is delivering the game currencies in the placement area of a winner, after completion of collecting the game currencies in the placement area of a loser, and
outputting alert information in a case that the actual settlement action does not match the settlement action required to be performed comprises:
outputting third alert information, in a case that it is detected that the game controller does not collect all of the game currencies in the placement area of the loser and delivers the game currencies in the placement area of the winner; wherein the third alert information indicates that the game controller does not collect all of the game currencies in the placement area of the loser and delivers the game currencies in the placement area of the winner.

11. The method of claim 3, wherein the plurality of frames of the first images comprise: at least one frame of a first sub-image, and at least one frame of a second sub-image shot after the at least one frame of the first sub-image; and
detecting the change information of the game currencies in each placement area based on the plurality of frames of the first images comprises:
determining a first attribute value of the game currencies in each placement area in the first sub-image, the first attribute value comprising at least one of a quantity or a total value;
determining a second attribute value of the game currencies in each placement area in the second sub-image; and
determining the change information of the game currencies in each placement area based on the first attribute value of the game currencies and the second attribute value of the game currencies for a same placement area.

12. The method of claim 3, wherein the plurality of frames of the first images comprise at least one frame of a third sub-image, and at least one frame of a fourth sub-image shot after the at least one frame of the third sub-image;
detecting the change information of the game currencies in each placement area based on the plurality of frames of the first images comprises:
determining that the game currencies in a predetermined placement area in each of the third sub-image are emptied; and
determining the change information of the game currencies in each placement area, in a case that game currencies exists in the predetermined placement area of each of the at least one fourth sub-image and attribute values of the game currencies are the same, wherein the attribute values comprise at least one of a quantity or a total value.

13. The method of claim 3, wherein the plurality of frames of the first images comprise at least one frame of a fifth sub-image, and at least one frame of a sixth sub-image shot after the at least one frame of the fifth sub-image;
detecting the change information of the game currencies in each placement area based on the plurality of frames of the first images comprises:
determining, in the fifth sub-image, a third attribute value of the game currencies in a first placement area corresponding to which a player is a winner and a fourth attribute value of the game currencies in a second placement area corresponding to which a player is a loser, each of the third attribute value and the fourth attribute value comprising at least one of a quantity or a total value;
determining, in the sixth sub-image, a fifth attribute value of the game currencies in the first placement area and a sixth attribute value of the game currencies in the second placement area; and
determining the change information of the game currencies in each placement area based on the third attribute value of the game currencies, the fourth attribute value of the game currencies, the fifth attribute value of the game currencies and the sixth attribute value of the game currencies.

14. An alerting device comprising:
a memory storing processor-executable instructions; and
a processor configured to execute the processor-executable instructions to perform operations of:
acquiring a result of a game played at a game table and a plurality of frames of first images obtained by shooting the game table at a settlement stage of the game, the game table comprising at least one placement area for placing game currencies;
determining, based on the plurality of frames of the first images, an actual settlement action of a game controller for each placement area, wherein the actual settlement action comprises at least one of an action of collecting the game currencies or an action of delivering the game currencies;
determining, based on the result of the game, a settlement action required to be performed by the game controller; and
outputting alert information in a case that the actual settlement action does not match the settlement action required to be performed.

15. The alerting device of claim 14, wherein the game table further comprises a game prop operation area, and acquiring the result of the game played at the game table comprises:
obtaining at least one frame of a second image obtained by shooting the game table at a game prop operation stage of the game;
determining information about game props within the game prop operation area based on the at least one frame of the second image; and
generating the result of the game according to the information about the game props.

16. The alerting device of claim 14, wherein determining, based on the plurality of frames of the first images, the actual settlement action of the game controller for each placement area comprises:
detecting change information of the game currencies in each placement area based on the plurality of frames of the first images; and
determining the actual settlement action of the game controller in each placement area based on the change information of the game currencies in each placement area.

17. The alerting device of claim 16, wherein the processor is configured to execute the processor-executable instructions to perform further operations of:
determining, based on the plurality of frames of the first images, a game currency operator associated with the change information of the game currencies in each placement area;
wherein determining the actual settlement action of the game controller in each placement area based on the change information of the game currencies in each placement area comprises:
in a case that the game currency operator is the game controller, determining the actual settlement action of the game controller in each placement area based on the change information of the game currencies in each placement area.

18. The alerting device of claim 14, wherein the plurality of frames of the first images are acquired as follows:
receiving the plurality of frames of the first images which are obtained by shooting the game table with at least one camera mounted on a side and/or top of the game table and sent by the at least one camera; or
receiving at least one video which is obtained by shooting the game table with at least one camera mounted on a side and/or top of the game table and sent by the at least one camera, and intercepting the plurality of frames of the first images from the at least one video.

19. The alerting device of claim 14, wherein outputting the alert information comprises outputting the alert information to a management system.

20. A non-transitory computer storage medium having stored thereon computer-executable instructions that, when executed by a processor, cause the processor to perform operations of:
acquiring a result of a game played at a game table and a plurality of frames of first images obtained by shooting the game table at a settlement stage of the game, the game table comprising at least one placement area for placing game currencies;
determining, based on the plurality of frames of the first images, an actual settlement action of a game controller for each placement area, wherein the actual settlement action comprises at least one of an action of collecting the game currencies or an action of delivering the game currencies;
determining, based on the result of the game, a settlement action required to be performed by the game controller; and
outputting alert information in a case that the actual settlement action does not match the settlement action required to be performed.
